(19) United States
(12) Patent Application Publication
(10) Pub. No.: US 2011/0142985 A1
(43) Pub. Date: Jun. 16, 2011

(54) ADDITIVE FOR ANIMAL FEED AND METHOD FOR THE PREPARATION THEREOF

(75) Inventors: Jean-Philippe Meunier, Cessy (FR); Christelle Raulet, Thyez (FR); Laurence Callejon, Saint Genis Pouilly (FR)

(73) Assignee: PANCOSMA Societe Anonyme pour I'Industrie des Produits Biochimiques, Le Grand Saconnex (CH)

(21) Appl. No.: 13/060,216

(22) PCT Filed: Aug. 18, 2009
(86) PCT No.: PCT/IB2009/006569

§ 371 Date: Feb. 22, 2011

(30) Foreign Application Priority Data
Aug. 19, 2008 (FR) 08.04617

(51) Int. Cl. A23K 1/18; A23L 1/03; A23P 1/08

(52) U.S. Cl. 426/2; 426/96; 426/302

(57) ABSTRACT

The invention relates to an additive intended in particular to promote feed uptake by animals such as piglets. This additive is in the form of granules each comprising at least one active plant extract and/or at least one flavouring incorporated into a matrix, each granule having a coating which comprises at least one sweetener and optionally at least one potentiator and at least one flavouring. The invention also relates to a method for preparing such an additive.

The invention relates to an additive intended in particular to promote the taking of feed by animals, such as piglets. The invention also relates to a process for the preparation of such an additive.

### BACKGROUND OF THE INVENTION

For economic reasons, in livestock, consumption should be optimum during the period of rearing. However, various situations (weaning, stress, infections, and the like) can be accompanied by an increased vulnerability in the health of the animal. In order to prevent this risk, the feed is sometimes supplemented with various additives, such as plant extracts.

This is because plants, due to their intrinsic active components, have shown that they can have a positive effect on the digestive environment. For this reason, they have been used for many years as additives in animal feed.

The use of plant extracts fully plays its part in the case of weakness of the animal: stress, heat, digestion problem, and the like, which states are generally accompanied by a fall in appetence and in the taking of feed. The result is that the animal enters a negative cycle, with a fall in consumption aggravating its physiological state.

Some plant extracts, such as essential oils, resins, oleoresins and flavorings, exist in the liquid form, indeed even the pasty form.

These plant extracts are sometimes used shortly after they are obtained. Their preservation can be assured only for a relatively short period of time, as prolonged storage over a few months, indeed even over a few weeks, results in a loss of their properties, which are often related to some of their highly volatile or oxidation-sensitive constituents.

It should also be noted that a liquid form is often difficult to disperse homogenously in the feed, hence the need to fix the plant extracts to a solid support which is provided in the powder form.

Moreover, some of the molecules of which these plant extracts are composed may:
be toxic or irritating to the handler,
present problems of aftertaste or of inappetence,
be incompatible with a coingredient used in the premixes or in the feed,
be sensitive to the various processes of manufacture of the feed (steam granulation, and the like).

Techniques for incorporation in a matrix have accordingly been developed.

Various techniques are currently used for the incorporation of plant extracts in a matrix. Mention may be made, by way of examples, of:
spray drying,
coacervation,
spray cooling/chilling,
extrusion,
granulation, and
fluidized bed granulation.

The products resulting from these incorporation techniques are essentially microparticles in which the plant extract is trapped in a matrix.

In such a configuration, a not insignificant portion of the active principles is found at the surface and thus in direct contact with the environment. This can have a negative impact on the consumption of the feed as the plant extracts may have a repellant or irritant gustatory effect which is disadvantageous to the taking of feed by the animal and results in a fall in its growth performance.

The aim is then to stimulate the appetite of the animal, in order for the latter to consume as much supplemented feed as possible, by offering it a feed having a sweet flavor which it particularly appreciates. This can be carried out by adding a sweetener directly to the matrix and to the plant extracts.

However, the plant extracts in the form of microparticles incorporated in a matrix are generally relatively large in size in order to promote the protective effect of the matrix (by reducing the specific surface and thus the surface area for exchange with the external environment) during storage or during their incorporation in the feed.

This is not without consequence on the distribution of the microparticles in the feed once granulated. The granules may then be highly heterogeneously dispersed, resulting in variations in the gustatory profile of the feeds, it being possible for one mouthful to exhibit a barely perceptible irritating taste, while the following mouthful may for its part be highly irritating, indeed even repellent, with an inadequate masking effect by the sweetener. This heterogeneity may have consequences with regard to the consumption of the animal, in particular in the youngest. For this reason, it is necessary for the amount of sweetener to be always present in the same proportion as the plant extract, this applying in each granule or mouthful.

In order to overcome this, a coating layer is sometimes added in order to completely separate the plant extracts from the external environment. Various coating excipients can be used, such as cellulose derivatives, hydrogenated fats, gums (gum arabic), and the like.

In additives normally introduced into animal feed, the coating excipients generally used are limited to neutralizing the problems of odor, of taste or irritation of the plant extracts used; they do not promote the consumption of these additives.

It was then envisaged to use sugar. Composed essentially of sucrose, this is a glucide which is appreciated by animals but it exhibits disadvantages, in particular its relatively high cost, its bulky nature, the risks of the caramelization thereof during heating of the feeds and the threat of it triggering diarrhea during the excessive consumption thereof.

### BRIEF ACCOUNT OF THE INVENTION

The present invention is thus targeted at overcoming the abovementioned disadvantages by virtue of a feed additive provided in the form of granules each comprising at least one active plant extract and/or at least one flavoring incorporated in a matrix, each granule being provided with a coating comprising at least one compound chosen from sweeteners.

In addition, this coating can optionally comprise at least one compound chosen from potentiators and flavorings.

The feed additive according to the invention thus combines the benefits of the plant extracts on the physiology of the animal with a sweetener-based coating which makes it possible not only to neutralize possible unpleasant tastes and to mask possible aftertastes but also to promote the taking of feed by stimulating the appetite of the animal.

Furthermore, it makes it possible to keep the active principle(s) intact with regard to the environment for a prolonged storage period.

The invention also relates to a process for the preparation of an additive according to the invention which comprises the following stages:
a first stage of formation of granules each comprising at least one active plant extract and/or at least one flavoring incorporated in a matrix;
a second stage of formation of a coating around the granules obtained above, this coating being formed with at least one compound chosen from sweeteners.

Thus, the process according to the invention makes it possible in particular:
to obtain a homogeneity in the distribution of the plant extracts and/or of the flavorings in the matrix;
to protect the active principle(s) and/or flavoring molecules during their incorporation in the feed, and
to protect the environment from potential toxicity of the active principle(s).

### DETAILED ACCOUNT OF THE INVENTION

### a) Additive According to the Invention

The additive according to the invention is provided in the form of granules, each of which comprises a matrix incorporating at least one active plant extract and/or at least one flavoring.

The term “active plant extract” should be understood as meaning, in the present account, a plant extract having an activity, that is to say an effect, in particular a therapeutic effect, on the condition of the animal. The active plant extract is preferably an active principle.

The term “flavoring” should be understood as meaning, in the present account, a feed additive intended to give a specific fragrance, odor or flavor to the feed.

The material constituting the matrix comprises at least one of the compounds chosen from maltodextrin, native or modified starch, gum arabic, guar gum, a lecithin, alginic acid or its derivatives, agar, locust bean gum, xanthan gum, sorbitol or its derivatives, mannitol, glycerol, a pectin, an alginate, a carrageenan, cellulose or one of its derivatives, a saponin, a hydrogenated fat, a glyceride of fatty acid or its derivatives or a mixture of at least two of these compounds.

The flavoring is a flavoring for use in feedstuffs as defined in particular by European Directive 88/388/EEC, which categorizes flavorings for use in feedstuffs into 5 families: natural, nature-identical, artificial, from transformation and from smoke.

There exists at least two reference works which list flavorings: “Perfume and Flavor Chemicals” by Steffen Actander and “Fenaroli's Handbook of Flavor Ingredients” by George A. Burdock.

The active plant extract can be highly varied in nature. It can, for example, be an oleoresin, an essential oil or an active principle which is natural or obtained from an essential oil.

It is also possible to use an artificial active plant extract, that is to say one obtained in all or part by organic synthesis.

According to the invention, each granule comprises a coating which comprises at least one compound chosen from sweeteners and can optionally comprise at least one compound chosen from potentiators and flavorings.

The sweetener is an agent which contributes the sweet taste. This can be saccharin, saccharin sodium, saccharin calcium, aspartame, acesulfame-K, a cyclamate, stevioside or optionally another intense sweetener of natural origin or of identical nature.

Of course, it is possible to use a combination of these sweeteners in any proportions.

Preferably, saccharin sodium is used as sweetener.

The second optional constituent of the coating is a potentiator. The latter has a two-fold effect. First, it prolongs the perception of the sweet taste which, in its absence, would be too fleeting. Subsequently, the potentiator generally has another effect of masking the secondary or unwanted tastes of the sweetener, for example of masking the bitter and metallic taste of saccharin or its sodium and calcium salts.

Use may be made, as potentiator, of glycyrrhizin, ammonium glycyrrhizinate, potassium glycyrrhizinate, sodium glycyrrhizinate or glycyrrhizinate of another alkali metal or alkaline-earth metal, thaumatin, kokumi, neoesperidin dihydrochalcone (NHDC) or a combination of these potentiators, in any proportions.

Use is preferably made, as potentiator, of monoammonium glycyrrhizinate.

The coating mixture can also comprise at least one flavoring, the role of which is also to mask the secondary or unwanted tastes of the sweetener. This flavoring of the coating can be identical to, similar to or different from the flavoring or flavorings found in the matrix.

The choice may in particular be made, as flavoring for the coating, of vanillin (3-methoxy-4-hydroxybenzaldehyde), ethyl vanillin (3-ethoxy-4-hydroxybenzaldehyde), another vanillin derivative which has a similar flavoring power, maltol or ethyl maltol.

Use is preferably made, as flavoring, of a mixture of vanillin and maltol.

Preferably, the coating according to the invention comprises:
from 50 to 100% by weight of sweetener(s);
from 0 to 25% and preferably from 0 to 5% by weight of potentiator(s); and
from 0 to 25% by weight of flavoring(s);
the sum of these constituents being, of course, equal to 100% by weight, with respect to the total weight of the coating.

Preferably, the core according to the invention comprises:
from 5 to 95% by weight of active plant extract(s) and/or of flavoring(s);
from 5 to 95% by weight of matrix; and
the sum of these constituents being, of course, equal to 100% by weight, with respect to the total weight of the core.

Preferably, the additive for animal feed according to the invention comprises:
from 10 to 90% by weight of the coating mixture;
from 10 to 90% by weight of the core;
the sum of these constituents being equal to 100% of the total weight of the additive.

The additive according to the invention can be used directly in the feed of farmed animals at a mean dose of 70 to 1000 g/t, preferably approximately 100 g/t.

### b) Process According to the Invention

### 1st Stage

The first stage of the manufacture of the additive according to the invention consists in forming granules, each comprising at least one active plant extract and/or at least one flavoring which is/are incorporated in a matrix.

It is optionally possible to add, to the matrix, one or more conventional emulsifier(s) or any compound having an emulsifying power.

Use may be made, for the formation of the granules, of any known granulation process.

An emulsion, generally an aqueous emulsion, comprising the active principle and the material which has to constitute the matrix can then be prepared.

Subsequently, the emulsion is sprayed in order to form the granules which are composed of the matrix incorporating the active principle.

Preferably, the technique used is a granulation by spraying in a fluidized bed. The advantage of this technique is that it offers the possibility of developing relatively spherical and homogeneous microparticles which make it possible to apply, in a second stage, a coating of good quality.

### 2nd Stage

The second stage consists in coating the microparticles obtained on conclusion of the first stage.

The coating is generally carried out using a sweetener optionally mixed with at least one potentiator and/or with at least one flavoring, preferably in the form of a solution, generally an aqueous solution.

This mixture or this solution is subsequently sprayed over the microparticles, which have preferably been suspended beforehand in a fluidized bed. The final product thus obtained is provided in the form of coated granules, the active plant extract/sweetener (and optionally potentiator(s) and/or flavoring(s)) distribution of which is homogeneous and the proportion of which can thus be constant in the feed.

### EXAMPLE

### Formulation

A formulation was prepared by using carvacrol as active principle and maltodextrin as matrix. The coating subsequently applied was composed of a mixture comprising a sweetener, a potentiator and flavorings.

### 1. Starting Materials

Carvacrol (2-methyl-5-(isopropyl)phenol) (Ernesto, Ventos, Barcelona, Spain) is used as active principle. Maltodextrin Granadex 20 (Avebe, Veendam, Holland) and modified starch Hi-Cap 100 (National Starch, France) are used as excipient for the granulation in a fluidized air bed. Finally, a mixture of saccharin, maltol and monoammonium glycyrrhizinate is employed as coating solution.

### 2. Preparation of the Microparticles

### 2.1 Preparation of the Formulation F1

In a first stage, the carvacrol is mixed with the maltodextrin and the water (table No. 1). The solution is then homogenized in a Niro Soavi, panda type, laboratory homogenizer (Niro Soavi France, Saint-Quentin-en-Yvelines, France) at a pressure of 250 bar in order to create an emulsion (micelles of less than 5 μm).

TABLE No. 1
Composition of the carvacrol-based
emulsion

| Compound | Amount (g) | Emulsion (%) | Solid (%) |
|---|---|---|---|
| Maltodextrin | 180 | 18 | 45 |
| Hi-Cap 100 | 100 | 10 | 25 |
| Carvacrol | 120 | 12 | 30 |
| Water | 600 | 60 | — |
| Total | 1000 | | 100.00 |

This composition is subsequently granulated by spraying in a fluidized air bed of Procell 5 type (Glatt GmbH, Weimar, Germany) according to the conditions described in table No. 2. After manufacture, the microparticles are sieved in order to obtain a homogeneous size of between 50 and 200 μm (formulation F1).

TABLE No. 2
Parameters for the granulation of the
formulation F1 in a fluidized air bed of Procell 5 type
(Glatt GmbH, Weimar, Germany)

| Parameters | Spraying via the bottom |
|---|---|
| Air flow rate (m³/h) | 100-140 |
| Temperature of the product (° C.) | 27-36 |
| Nozzle (mm) | 1 |
| Spraying air pressure (bar) | 2.5 |
| Spraying flow rate (g/min) | 15 |

### 2.2 Preparation of the Formulation F2

The coating of the composition F1 is carried out in a fluidized air bed of Procell 5 type using, as coating excipient, a sweetener-based mixture (table No. 3). A saccharin sodium solution is prepared by introducing 0.780 liter of water into a vessel, by heating up to 70° C., by then slowly adding 1.051 kg of saccharin sodium and by stirring the solution for 30 minutes until dissolution is complete (the solution becomes transparent). Subsequently, the monoammonium glycyrrhizinate and the flavoring of maltol type are slowly added and then dissolution is allowed to proceed with stirring at 70° C. for 30 minutes. When the solution obtained becomes transparent, the coating operation is carried out in a fluidized air bed, the operating conditions of which are described in table No. 4. Coating is carried out until 50% (w/w) of the final product, that is to say until the formulation F2 is obtained (table No. 5).

TABLE No. 3
Composition of the coating formulation

| Compound | Amount (g) | Emulsion (%) | Solid (%) |
|---|---|---|---|
| Saccharin sodium | 1.077 | 57.2 | 97.4 |
| Maltol | 0.022 | 1.2 | 2.3 |
| Monoammonium | 0.003 | 0.2 | 0.3 |
| glycyrrhizinate | | | |
| Water | 0.780 | 41.4 | 0.0 |
| Total | 1.882 | 100 | 100.00 |

TABLE No. 4
Parameters for the coating (50%, w/w) of
the formulation F1 in a fluidized air bed of Procell 5
type (Glatt GmbH, Weimar, Germany)

| Parameters | Spraying via the bottom |
|---|---|
| Air flow rate (m³/h) | 120-300 |
| Temperature of the product (° C.) | 27-36 |
| Nozzle (mm) | 1.2 |
| Temperature of the nozzle (° C.) | 70 |
| Spraying air pressure (bar) | 2.5 |
| Temperature of the product (° C.) | 48-50 |
| Spraying flow rate (g/min) | 56-86 |

25

TABLE No. 5
Composition of the formulation F2

| Compound | Percentage by weight |
|---|---|
| Formulation F1 | 50 |
| Saccharin sodium | 47.3 |
| Vanillin | 1.4 |
| Maltol | 1.2 |
| Monoammonium glycyrrhizinate | 0.2 |
| Total | 100 |

1. An additive for animal feed provided in the form of granules, wherein:
each granule comprises a microparticle composed of at least one active plant extract and/or at least one flavoring incorporated in a matrix comprising at least one compound chosen from maltodextrin, native or modified starch, gum arabic, guar gum, a lecithin, alginic acid or its derivatives, agar, locust bean gum, xanthan gum, sorbitol or its derivatives, mannitol, glycerol, a pectin, an alginate, a carrageenan, cellulose or one of its derivatives, a saponin, a hydrogenated fat, a glyceride of fatty acid or its derivatives; and
each microparticle is provided with a coating comprising at least one compound chosen from sweetener provided with a coating comprising at least one compound chosen from sweeteners.

2. (canceled)

3. The additive for animal feed as claimed in claim 1, in which the sweetener is chosen from the group consisting of saccharin, saccharin sodium, saccharin calcium, aspartame, acesulfame-K, cyclamates, steviosides and their mixtures.

4. The additive for animal feed as claimed in claim 3, in which the sweetener is saccharin sodium.

5. The additive for animal feed as claimed in claim 3, in which the sweetener is a stevioside.

6. The additive for animal feed as claimed in claim 1, in which the coating additionally comprises at least one potentiator.

7. The additive for animal feed as claimed in claim 6, in which the potentiator is chosen from the group consisting of glycyrrhizin, ammonium glycyrrhizinate, potassium glycyrrhizinate, sodium glycyrrhizinate or the glycyrrhizinate of another alkali metal or alkaline-earth metal, thaumatin, kokumi, neohesperidin dihydrochalcone (NHDC) and the mixtures of at least two of these compounds.

8. The additive for animal feed as claimed in claim 1, in which the coating additionally comprises at least one flavoring.

9. The additive for animal feed as claimed in claim 8, in which the flavoring is chosen from the group consisting of vanillin, ethyl vanillin, maltol, ethyl maltol and their mixtures.

10. The additive for animal feed as claimed in claim 1, comprising:
from 10 to 90% by weight of coating;
from 10 to 90% by weight of core;
the sum of these constituents being equal to 100% of the total weight of the additive.

11. The additive for animal feed as claimed in claim 1, in which the coating comprises:
from 50 to 100% by weight of sweetener(s);
from 0 to 25% and preferably from 0 to 5% by weight of potentiator(s); and
from 0 to 25% by weight of flavoring(s);
the sum of these constituents being equal to 100% of the total weight of the coating.

12. The additive for animal feed as claimed in claim 1, in which the core comprises:
from 5 to 95% by weight of plant extract(s) and/or of flavoring(s);
from 5 to 95% by weight of matrix; and
the sum of these constituents being equal to 100% of the total weight of the core.

13. A feed for farmed animals, comprising from 70 to 500 g/t of additive as claimed in claim 1.

14. Method of promoting the taking of feed by an animal, comprising feeding the animal with an additive as claimed in claim 1.

15. A process for the preparation of an additive for animal feed as claimed in claim 1, comprising:
preparing an emulsion which comprises at least one active plant extract and/or at least one flavoring and the material which has to form the matrix and which comprises at least one compound chosen from maltodextrin, native or modified starch, gum arabic, guar gum, a lecithin, alginic acid or its derivatives, agar, locust bean gum, xanthan gum, sorbitol or its derivatives, mannitol, glycerol, a pectin, an alginate, a carrageenan, cellulose or one of its derivatives, a saponin, a hydrogenated fat and a glyceride of fatty acid or its derivatives;
spraying the emulsion in order to form microparticles; and
forming a coating around the microparticles obtained above with at least one compound chosen from sweeteners.

16. The process for the preparation of an additive for animal feed as claimed in claim 15, in which, in the second stage, the coating is formed with, in addition to the sweetener(s), at least one potentiator and/or at least one flavoring.

17. The process as claimed in claim 15, in which the first stage comprises a granulation by spraying in a fluidized bed.

18. The process as claimed in claim 17, in which, in the first stage, the plant extract(s) and/or the flavoring(s) and the materials which have to form the matrix and optionally one or more emulsifier(s) are put into the form of an emulsion which is subsequently sprayed in order to form the granules.

19. The process as claimed in claim 18, in which the emulsion is an aqueous emulsion.

20. The process as claimed in claim 15, in which the second stage comprises the suspending of the granules in a fluidized air bed.

21. The process as claimed in claim 15, in which, in the second stage, the sweetener, the optional potentiator and/or the optional flavoring are mixed and then sprayed over the granules.

22. The process as claimed in claim 21, in which the sweetener and the optional potentiator and/or the optional flavoring are mixed in water and then the solution obtained is sprayed over the granules.
